(19) United States
(12) Patent Application Publication
(10) Pub. No.: US 2008/0013896 A1
(43) Pub. Date: Jan. 17, 2008

(54) MINIATURE OPTICAL TRANSCEIVER

(76) Inventors: Jose B. Salzberg, Naperville, IL (US); Mark Margolin, Highland Park, IL (US); Gregory Bunin, Deerfield, IL (US)

Correspondence Address: PATZIK, FRANK & SAMOTNY LTD., 150 SOUTH WACKER DRIVE, SUITE 1500, CHICAGO, IL, 60606, US

(21) Appl. No.: 11/427,113

(22) Filed: Jun. 28, 2006

(51) Int. Cl. G02B 6/36

(52) U.S. Cl. 385/89

(57) ABSTRACT

A miniature optical transceiver system where active transmitter and receiver components are mounted on the same circuit board in perpendicular relation to the mother board, including means for precise passive alignment of the optical fibers to the active components such as the VCSEL and PD.

### FIELD OF INVENTION

The present invention relates generally to fiber optic transceiver devices, and more specifically to a method and apparatus for fiber optic data receipt and transmission in a miniaturized environment such as a wireless phone or the like.

### BACKGROUND OF INVENTION

The speed of data transfers in devices such as wireless phones is ever increasing. Due to increasing needs for bandwidth, there is increasing reliance on optical signal transmission through fiber optic cabling. With fiber optic data transmission, data is transmitted using light signals, rather than electrical signals. A logical one may be represented by a light pulse of a specific duration, and a logical zero may be represented by absence of a light pulse for the same duration. It is also possible to transmit multiple distinct data streams as multiple colors of light over a single strand of optic fiber. The bandwidth of optic fiber is significantly greater than conventional copper wire. Generally speaking fiber can carry data at higher speed and over longer distances than copper wire.

Light emitting diodes (“LEDs”) or lasers are used to send the light signals through a fiber-optic cable. To send data, the data is typically converted from electronic data to optical data that can be propagated onto the fiber-optic cable. When data is received from a fiber-optic cable, the data must be converted from optical data to electronic data. When optical data is received, a photodiode, in conjunction with other circuitry, converts the optical data into electronic data.

Vertical Cavity Surface Emitting Lasers (“VCSELs”) are a relatively new class of semi-conductor lasers. In a VCSEL, optical emission occurs normal to the plane of a PN junction. VCSELs have advantages over edge-emitting laser diodes. These advantages include smaller optical beam divergence and better-defined and more circular laser beams. Hence, VCSELs are well suited for use in optical transceivers in combination with laser driver circuitry as part of the transmitter operation (“Tx”).

For the receiver operation (“Rx”) of an optical transceiver, photodiodes (“PD”) are most often used in combination with Transimpedance Amplifiers and Limiting Amplifiers (“TIA/LA”) components.

Fiber optic transceivers are used for the conversion of optical and electrical signals, and vice versa. Some of the drawbacks of existing fiber optic transceivers are that they are generally expensive, difficult to fabricate and too large. Hence, there is a continued need for improved optical transceivers.

### SUMMARY OF INVENTION

The optical transceiver can be used in cellular or wireless phone applications to provide high speed links in flip phones, flip and twist phones, slide phones, handheld PDAs, MP3 players, video cameras, PCs, laptops and the like. In addition, the present invention has application in automotive networks for monitoring engine operation, as well as DVD players or other systems providing entertainment to passengers. Likewise, the system of the present invention can be used with Ethernet-based networks so as to enable higher port density than conventional SFP systems, including Ethernet systems with capacities of 1 gigabit per second or higher.

The optical transceiver of the invention is compact with dimensions of 15 mm ×2.6 mm ×1 mm and provides a duplex link with transmission of data (“Tx”) and receiving of data (“Rx”) on a single printed circuit board. Transmission operation or Tx is capable of speeds up to at least 2.5 Gb/s and the receiving operation or Rx is capable up of speeds up to at least 2.5 Gb/s. A small pin count is provided by providing power, signal and ground for both TX and RX on the single circuit board.

A major, costly issue of transceiver products is the need for extremely precise alignment of the fiber cores to the active optical components (VCSEL and Photo Diode (“PD”)), necessitating active alignment techniques. This is costly in both time and equipment. The present invention provides a means of passive alignment of the optical fibers to the VCSEL and PD by means of mechanical alignment features built into the unit, along with the use of large core optical fibers such as plastic optical fiber (“POF”). For applications requiring short transmission distances under 5-6 inches, plastic optical fiber has sufficient bandwidth to accommodate speeds up to and exceeding 2.5 Gb/s. Plastic optical fiber has a minimum in its optical absorption near 670 nm and is very absorptive in the 850 nm range. Others have tried to make VCSELs operate at or near 670 nm to take advantage of the absorption minimum. However, such VCSELs have unproven reliability. The present invention demonstrates for short links that highly reliable commercially available VCSELs operating at 850 nm work very well in data links in the highly absorptive region of the POF as long as the fiber lengths are 5-6 inches or less.

The present invention includes a miniature optical transceiver assembly having transmission means and receiver means affixed to at least one circuit board comprising: at least one optical fiber having two opposite ends and operably connected at least one end to at least one of the transmission means and said receiver means. The housing serves as an adapter and connector in paired relationship, operably interposed between the optical fiber and at least one of the transmission means and receiver means, to secure the optical fiber in engaged and aligned position with respect thereto. The optical fiber is surrounded by a flexible sheath to permit movement of the fiber without damage if the sheath is moved, bent or twisted.

The transmission means comprises a laser driver and a VCSEL. The receiver means comprises a photodiode and a TIA/LIA component.

The optical transceiver assembly has first and second ends and at least one transmission means and at least one receiver means operably affixed at each end to at least one circuit board. The assembly further comprises at least two optical fibers having two opposite ends and operably connected at each end to at least one of the transmission means and at least one of the receiver means. A housing serves as an adapter and connector in paired relationship, operably interposed between the optical fiber and the at least one of said transmission means and receiver means, to secure the optical fiber in engaged and aligned position with respect to at least one of the transmission means and at least one of the receiver means at each end.

Each housing has at least one ferrule portion positioned therein to carry at least one of the fibers. The housing further includes an alignment mechanism for precisely aligning the fibers with at least one of the transmission means or the receiver means. The housing further includes an engagement mechanism for retaining the fibers in engaged and aligned position with respect to the transmission or receiver means. The optical fibers are surrounded by a flexible sheath for at least a portion of the span from one end of the fibers to the other to permit movement of one end of the assembly with respect to the other, without damage to the fibers.

The housing further comprises: at least one fiber optic connector comprising at least one ferrule for carrying the fibers; and, a fiber optic adapter interposed between the connector and the board for detachably capturing said connector and operably attaching it to said circuit board. The alignment mechanism comprises: the circuit board having at least one predetermined alignment hole formed therein and at least one alignment groove. The housing has a pin portion protruding therefrom for aligned receipt by the alignment hole in the circuit board. The housing further has one or more prongs protruding therefrom for receipt by the one or more alignment grooves of the circuit board.

The engagement mechanism comprises: the adapter having one or more slots; the connector having one or more latches about a substantially open interior for receipt of the adapter within the interior thereof; and, the latches of the connector engaging the slots of the adapter and thereby retaining the connector in the interior of the adapter.

The invention further comprises an optical transceiver assembly for mounting on a mother board comprising: a circuit board; a laser driver operably mounted to said circuit board; a VCSEL or other type of laser operably connected to the laser driver and mounted on said circuit board; and the laser driver and VCSEL cooperating to provide transmitter operation. A photodiode in combination with a TIA/LA or other type of fiber optic receiver provide receiver operation operably mounted on the circuit board. The circuit board is operably affixed to the mother board in a perpendicular orientation thereto so as to provide that the fibers are oriented in parallel relation to the motherboard when connected thereto.

The invention further includes a method for passively aligning the optical fibers to the active components of an optical transceiver including a circuit board and an adapter/connector pair comprising: forming at least one alignment hole and at least one alignment groove into the circuit board at positions that will result in precise alignment of the optical fibers with the active components of the optical transceiver; providing an alignment pin and posts on the adapter/connector pair for corresponding engagement with the alignment hole and alignment groove of the adapter/connector pair; mounting the active optical components to the circuit board at specified locations thereon; and, joining the adapter/connector pair to the circuit board so that the alignment pin and alignment post are received by the corresponding alignment hole and alignment groove in secure and precisely aligned fashion. The order of the foregoing method could be altered slightly without escaping the scope of the invention.

The optical transceiver of this invention includes use in devices having a first portion and a second portion that can each be moved with respect to the other portion. The transceiver has transmission means and receiver means affixed to a circuit board comprising: at least one optical fiber operably connected to the circuit board in precisely aligned fashion with respect to the transmission means and the receiver means.

At least one adapter/connector pair is interposed between the optical fiber and the transmission means and the receiver means, to secure the optical fiber in engaged and precisely aligned position with respect thereto. The optical fiber is surrounded by a flexible sheath so as to permit passage of the fiber from the first portion of the device to the second portion of the device without damage to the fiber when one of the device portions move with respect to the other.

The movement of the first portion of the device with respect to the second portion can be rotation about a single axis defined by a hinge between the first and second portions. The movement of the first portion of the device with respect to the second portion can also be rotation about either of two axes defined by one or more hinges positioned between the first and second portions. The movement of the first portion of the device with respect to the second portion is sliding of a first portion of the device with respect to the second portion thereof.

The invention can be used in electronic devices containing active optical components having a first portion that moves with respect to a second portion of the device. It comprises a first transceiver having transmission means and receiving means operably affixed to a circuit board within the first portion of the device; a second transceiver having transmission means and receiving means operably affixed to a circuit board within the second portion of the device; at least one optic fiber operably connected to the first transceiver and the second transceiver and extending therebetween so as to enable the sending and the receiving of data therebetween;

An alignment mechanism is interposed between the optic fiber and the circuit board for precise passive alignment of the fiber with the active optical components; and, a protective sheath surrounds the fibers and prevents damage to the fibers when the portions of the device are moved with respect to one another. The alignment mechanism comprises the active optical components being operably mounted to a circuit board at each portion of the device; the circuit board having at least one alignment hole formed therein at a desired location; the fiber being mounted to a adapter/connector pair at one end; and the adapter/connector pair having a pin member at a desired location for receipt by the alignment hole in the circuit board.

The invention further includes an optical transceiver system for use in electronic devices containing active optical components. The system comprises: a first transceiver having transmission means and receiving means operably affixed to a circuit board; a second transceiver having transmission means and receiving means operably affixed to a circuit board; at least one optic fiber operably connected to the first transceiver and the second transceiver and extending therebetween so as to enable the sending and the receiving of the optical signal therebetween; and, a hermitization material applied to the optical components so as to substantially cover the optical components.

The optical transceiver assembly has transmission means and receiver means for sending and receiving an optical signal, with the assembly affixed to at least one circuit board comprising: at least one optical fiber having two opposite ends and operably connected at least one end to at least one of the transmission means and the receiver means. The transmission means and the receiver means each include at least one active component. A housing serves as an adapter and connector in paired relationship, operably interposed between the optical fiber and the active components, to secure the optical fiber in engaged and aligned position with respect thereto; and, the adapter being formed of a transparent material so as to separate said fiber and said active component and facilitate hermitization of the active component with hermitizing material. The active components comprise a VCSEL and a PD. The hermitizing material is a transparent optical adhesive or gel. The adapter has a lens formed therein for optimal launching of the optical signal from the transmission means, in particular the VCSEL, to the fiber.

Additional features and advantages of the invention will be set forth in the description that follows. These and other features of the present invention will become more fully apparent from the following description and appended claims.

### BRIEF DESCRIPTION OF DRAWINGS

The following drawings depict only typical embodiments of the invention and are intended to illustrate embodiments of the invention and not its scope.

FIG. 1 is a schematic top view of the circuit board, showing the placement of the active components.

FIG. 2 is a block diagram of the circuit board.

FIG. 3 is a side cross-sectional view of an optical block dual sheath embodiment of the assembly.

FIG. 4 is a side perspective view of the optical block dual sheath embodiment.

FIG. 5 is a side perspective view of an optical block single sheath embodiment of the assembly.

FIG. 6 is a top perspective view of the cable assembly.

FIGS. 7A and 7B are exploded views of the adapter/connector pair system version of the assembly.

FIG. 8 is a perspective view of the assembled adapter/connector pair system.

FIG. 9 is a side cross-sectional view of the assembled adapter/connector pair system of FIG. 8.

FIG. 10 is a perspective view of the assembled adapter/connector pair system connected to the circuit board which is mounted on the mother board.

FIG. 11 is a schematic of two connected pairs of photonic receivers and transmitters.

FIGS. 12A and 12B are schematics of a device having a single flip axis.

FIGS. 13A and 13B are schematics of a twist and flip hinge type device.

FIGS. 14A and 14B are schematics of a device with portions that slide.

### DETAILED DESCRIPTION OF DRAWINGS

The present invention is described with reference to a couple of embodiments, as illustrated in the accompanying drawings. In the following description, numerous specific details are set forth in order to provide a thorough understanding of the present invention. It will be apparent to one of skilled in the art, that the present invention may be practiced without some or all of these specific details. In other instances, well-known operations have not been described in detail.

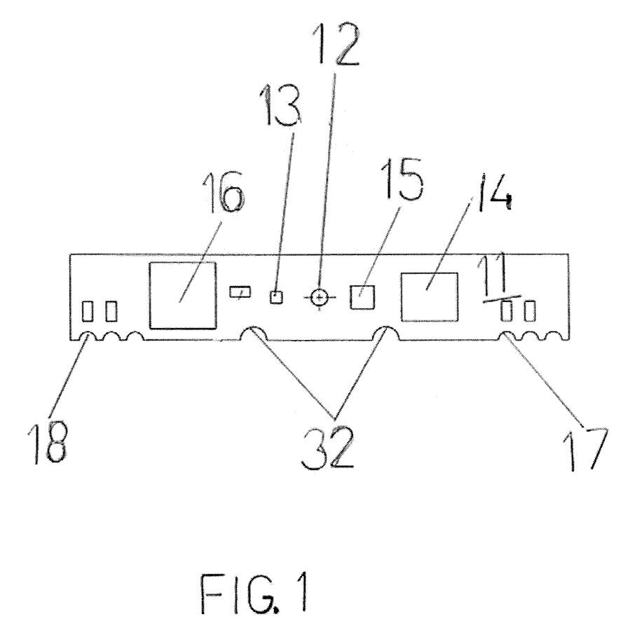

The present invention pertains to a miniature optical transceiver. As shown in FIG. 1, a first embodiment of the invention includes transceiver board 11 that contains single positioning hole 12, and positions 13 and 16 for optical emitter assembly Tx 13, 16 and optical receiver assembly Rx 15,14, respectively.

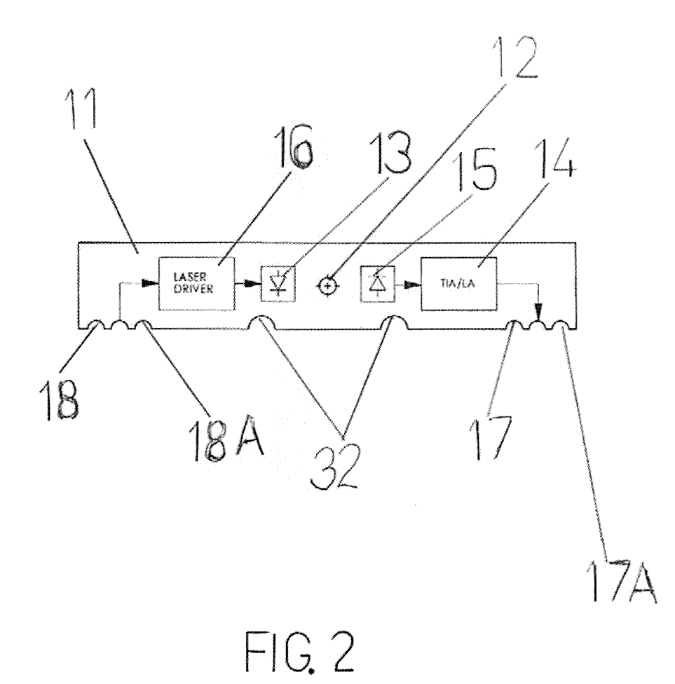

Turning to FIG. 2, a schematic view is provided of one embodiment of transceiver board 11. This embodiment uses alignment hole 12 to reduce alignment complexity. In that way the photonic components of the type previously discussed, can be placed relative to the reference hole 12, with a precision die attach tool in a known way, so as to allow use of a passive fiber coupling method. The hole 12 is positioned between laser driver 16 and VCSEL 13 on one side, and PD 15 and TIA/LA 14 on the other side. Grooves 18A and 17A enable connection to power ground signal for Tx 18 and for Rx 17, respectively.

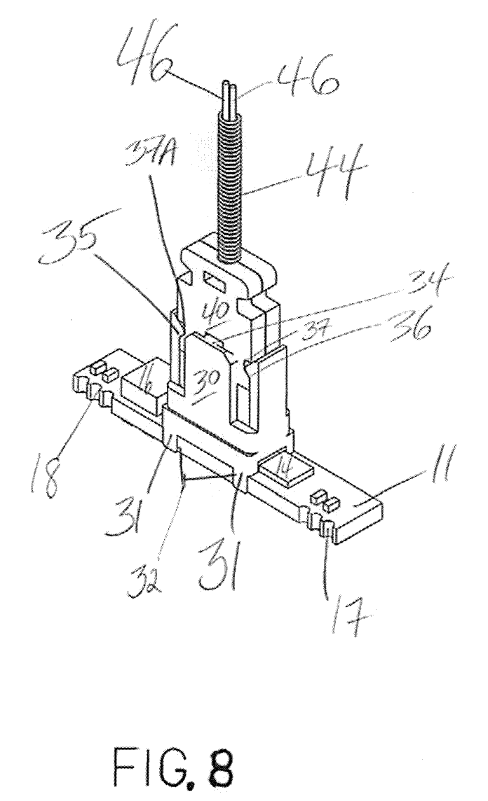

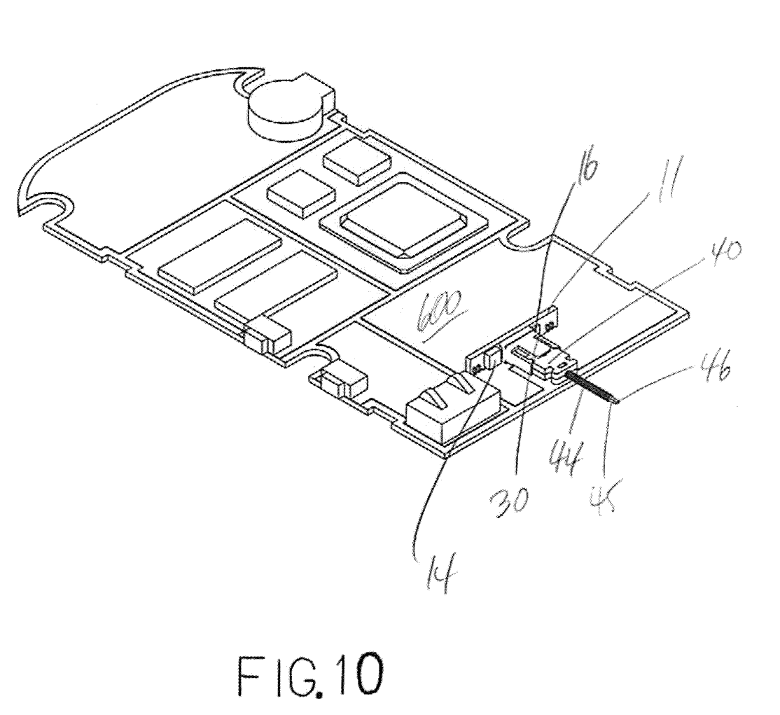

Transceiver board 11 is of a compact size. In the embodiments illustrated herein, its dimensions are approximately 15 mm ×2.6 mm ×1 mm. Grooves 17 and 18 are provided for receipt of power ground signal. Cutouts 32 are provided for receipt of prongs or posts 31 of the adapter 30 as shown in FIG. 8. The combination of alignment hole 12 and cutouts 32 of board 11 provide for location of large core optical fibers such as POF very precisely with respect to the Tx and Rx assemblies. The benefits of the alignment technique are best achieved with a large core fiber such as POF. In this way, because of the configuration of the transceiver board 11, the fibers are provided in parallel relation to the motherboard 600 (as shown in FIG. 10) on which the board 11 is mounted.

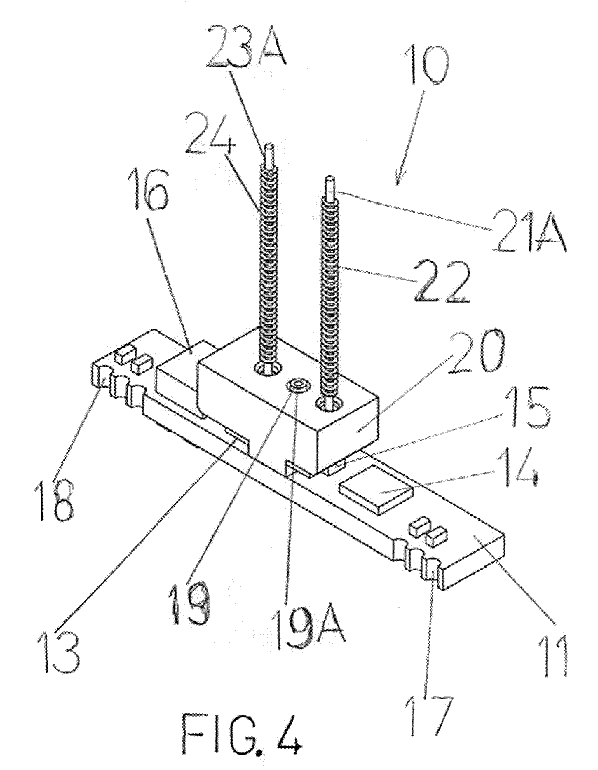

With reference to FIG. 4, a first embodiment of optical transceiver 10 mounted on transceiver board 11 is shown. Transceiver 10 thus provides a duplex link with both a Tx assembly comprising Laser Driver 16 connected to VCSEL 13 (not shown) and Rx assembly comprising Photo Diode (PD) 15 connected to Transimpedance Amplifier/Limiting Amplifier (TIA/LA) component 14 being mounted on a single transceiver board 11.

In the embodiment of FIG. 4, plastic optical fibers (“POF or fibers”) 21A and 23A each are terminated with their own ferrules 21 and 23 (not shown) at their ends, respectively, and fiber retaining sheaths 22 and 24 along their respective lengths. For any of the embodiments described herein, the sheath is formed of a spring-like coiled material that provides a hollow interior passage for the fibers to pass. The spring-like flexible sheath may be formed from a coiled wire (such as the brake cable of a bicycle) or other known elastic or flexible materials such as plastic, so as to permit bending or movement of the fiber within the sheath, without breakage. In order to prevent breakage of the fiber contained therein, the sheath should limit the radius of bending or movement of the fiber so as to keep possible rotation or movement of the fiber within a safe range to minimize or prevent breakage or excessive losses. The optical fibers and the fiber sheath assemblies must be flexible enough to bend without crimping or breaking within the hinges of phones, DVD players, laptops, etc. during normal use over several years of use.

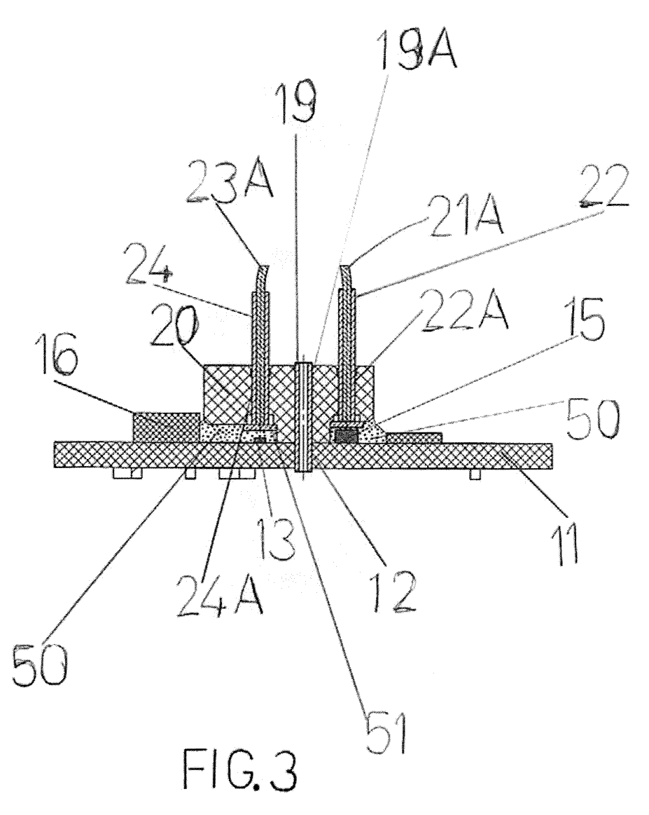

As shown in FIGS. 3 and 4, optical fibers 21A and 23A are carried inside ferrules 22 and 24, in this embodiment of the invention. Ends of the fibers 23A and 21A are terminated within ferrules 22 and 24 respectively and are operably positioned and received within optical block 20. Opposite ends of fibers 21A and 23A (not shown) are similarly connected to another transceiver board (not shown) in the same manner. Alignment pin 19 passes through central bore 19A in optical block 20 and alignment hole 12 in board 11, so as to provide facilitated and precise alignment of ferrules 24 and 22 with Tx assembly 13 and Rx assembly 15 respectively, of the transceiver 10. Ferrules 22 and 24 are received in corresponding passages 22A and 24A formed in optical block 20 until they contact optical windows or lenses 51. Clear hermetic gel 50 is provided for hermitization to substantially surround VCSEL 13 of Tx assembly; and PD 15 of Rx assembly so as to prevent unwanted moisture contacting the Tx assembly or the Rx assembly.

Positioning pin 19 spans the interior of central bore 19A as well as alignment hole 12, in order to align optical interface block 20 with alignment hole 12 of board 11, as shown in FIG. 3.

The POF specifications for the embodiments described herein comprise the following:
Core diameter of 235μ;
Core material of polymethyl methacrylate;
Core refractive index of 1.49;
Cladding diameter of 250μ;
Fiber NA of 0.63;
Attenuation loss (λ850 nm) of 3.0 dB/m;
Bending loss (λ850 nm, R 4 mm) of 0.02 dB;
Bending durability (ambient t°) 600K cycles;
Bending durability (cycles −40° C. to 85° C.) 400 k cycles;
Bandwidth˜1 GHz/m.

The transceiver embodiment examples described herein employ a Transmitter comprising an AlGaAs Oxide VCSEL and having: a 12 μm Aperture; and a 1.8 mA Threshold Current. Likewise, the examples discussed herein employ a Receiver comprising a Silicon PIN Photodiode having a 250 μm Active Area. Other optical transmitters and receivers known in the art should be considered as usable without departing from the scope of the invention.

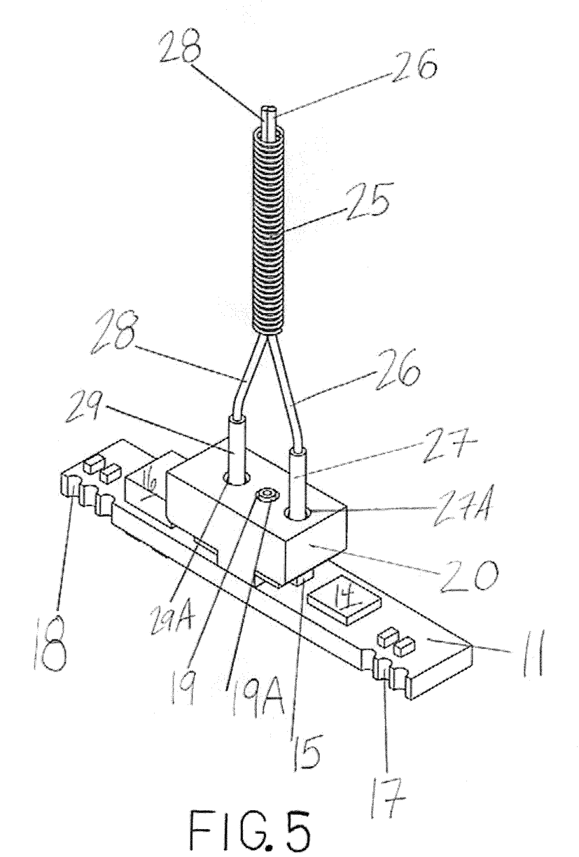

Alternatively, as shown in FIG. 5, another embodiment using a different duplex fiber management arrangement is provided wherein optical interface block 20 is attached to board 11 with laser driver operably connected to VCSEL 13 for Tx operation and Photodiode (PD) detector 15 operably connected to TIA/LA for Rx operation on board 11. Optical block 20 is aligned with board 11 by alignment pin 19 in the same manner described with respect to FIG. 4. Optical fibers 26 and 28 have ferrules 27 and 29 terminated and operably affixed at the ends shown in FIG. 5. However, a single fiber retaining sheath 25 carries and protects both fibers 26 and 28, in the embodiment of FIG. 5.

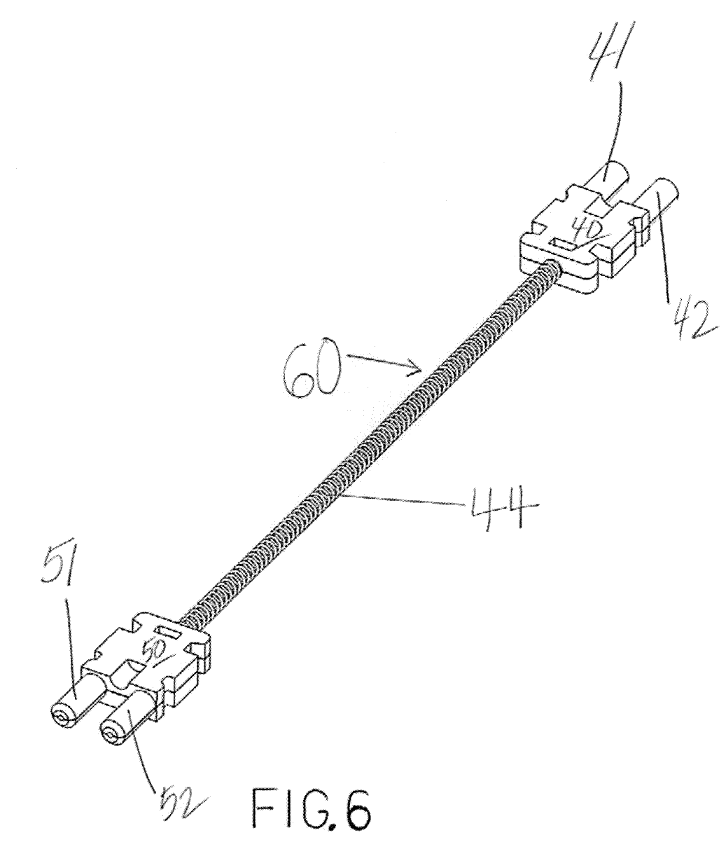

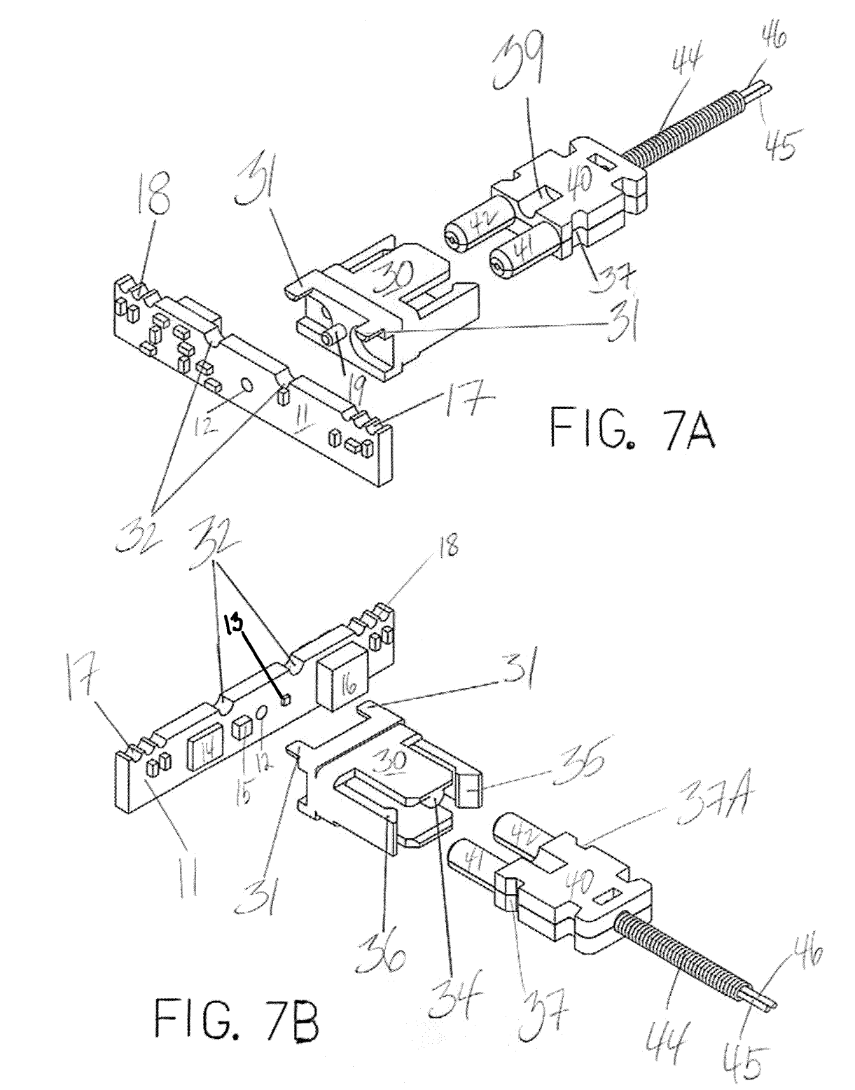

The single filament, multiple fiber cable assembly 60 is shown with fibers (not shown) retained within sheath 44 in FIG. 6. Ferrules are integrally formed as connector legs 51, 52 at one end and connector legs 41, 42 at the opposite end. Connectors 40 and 50 have integrally formed ferrule legs 41, 42 and 51, 52 respectively and serve to protect the fibers carried within single flexible sheath 44. Sheath 44 and the fibers 45, 46 contained therein (see FIGS. 7A and 7B) are flexible enough to pass through the hinge of a cell phone, video camera, laptop etc. and not become damaged or break during years of normal operation of the device in both normal and extreme conditions, as when the device and its hinge are subjected to rotation, bending, bending-and-rotation or sliding type motion of the display portion with respect to the base portion. Sheath 44 and the fibers 45, 46 carried therein thereby connect the display half of the device to the base half and transmit data therebetween.

Cable assembly 60 with connectors 40 and 50 is operably connected to board 11 carrying both Tx assembly 16, 13 as well as Rx assembly 15, 14 in the manner shown in FIGS. 7A and 7B. As shown in the exploded views of FIGS. 7A and 7B with respect to connector 40 of cable assembly 60, adapter 30 is interposed between connector housing 40 and board 11.

Adapters 30 are preferably made from a transparent material so as to allow formation of a clear lens for better launching of the optical signal from the VCSEL into the fiber. A lens can be formed integral to the transparent adapter housing. The transparency of the adapter material allows separation of the fiber and the active components. It further facilitates hermitization of the active component with transparent optical adhesive or gel. It is preferable that both active components, i.e. the VCSEL and the PD, are hermetizised with optical adhesive or gel.

Posts or prongs 31 of adapter 30 are received by notches 32 of board 11 for secure and aligned receipt of ferrule legs 41 and 42 of connector housing 40 within adapter 30 as shown in FIG. 8. Inner post 34 of adapter 30 corresponds to indent 39 on connector housing 40 to facilitate aligned engagement of connector housing 40 within the interior of adapter 30. Alignment post 19 of adapter 30 is located in alignment hole 12 for proper alignment of the connector/adapter combination with the photonic components of board 11.

As shown in FIG. 8, fibers 45, 46 within sheath 44 are properly aligned with the Tx assembly and the Rx assembly in engaged fashion due to the engagement of posts 31 of adapter 30 with board 11. Connector 40 is further engaged and held with ferrule legs 41 and 42 in the proper aligned position with respect to the Tx and Rx assemblies on board 11, by latches 35 and 36 of adapter 30 which securely engage side slots 37 and 37A of connector housing 40.

If necessary during a repair or assembly operation or the like, to remove connector 40 from adapter 30 once engaged, a force must be applied to latches 35, 36 of sufficient magnitude to overcome their inward bias, dislodge latches 35, 36 from side slots 37, 37A and enable the user to pull connector housing 40 away from the interior of adapter 30.

The connector 50 on the opposite end of cable assembly 60 (not shown in FIG. 8) can be similarly engaged in aligned fashion to another adapter and transceiver board (not shown) in the same operative manner.

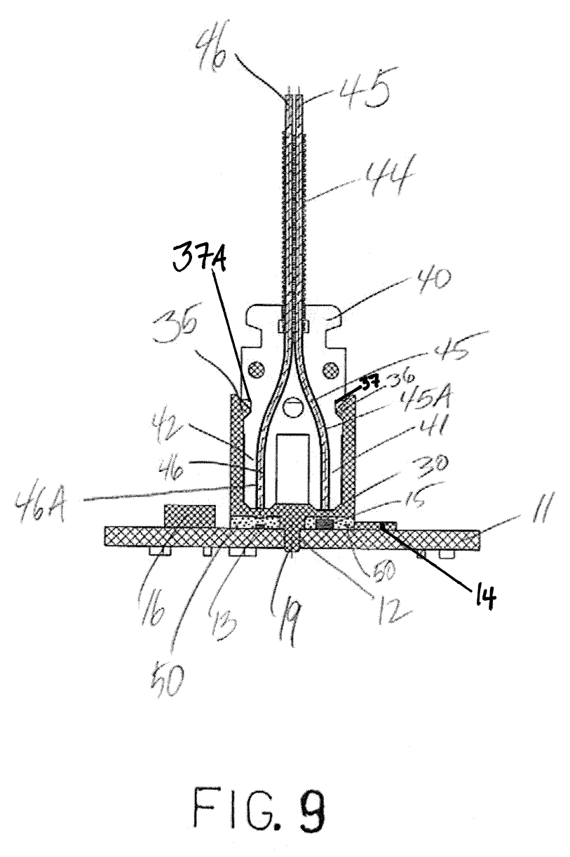

Fibers 45 and 46 are shown in FIG. 9 with connector housing 40 within single, flexible sheath 44. Connector housing 40 is shown in FIG. 9 fully engaged within adapter 30 which is preferably clear to enable the placement of an optical lens between fibers and active components. Posts 31 are received within slots 32 in board 11 (See FIG. 8) for consistent proper alignment of ferrule legs 41 and 42 with Tx assembly 13, 16 and Rx assembly 14, 15 respectively. As shown in the cross-sectional view of FIG. 9, fibers 45, 46 are carried through the interior passages 45A and 46A of connector housing 40 and ferrule legs 41, 42. Adapter 30 serves to align and retain the ferrules 41, 42 integrally formed as part of connector housing 40 in proper alignment with the Tx and Rx assemblies, respectively. As shown in FIG. 9, once connector housing 40 is inserted into the interior of adapter 30, latches 35 and 36 engage and retain side slots 37 and 37A in the connector housing 40 so as to retain the ferrules 41 and 42 and fibers 45 and 46 contained therein in proper alignment with respect to the previously described photonic components mounted on transceiver board 11. Similarly, connector housing 50 is securely engaged in proper alignment with corresponding second transceiver board at the opposite end of cable assembly 60 (not shown).

The substantially parallel orientation of the fibers 45, 46 within sheath 44 and connector housing 40 (engagedly received by adapter 30) relative to the mother board 600 to which transceiver board 11 is mounted, is shown in FIG. 10. The circuit board 11 can either be soldered in place or a miniature electronic connector can be used to both connect and hold the circuit board in place.

Though the adapter/connector pairs are shown as 2-piece housings or structures that together function as single structures in the examples discussed herein, alternatively they could be 1 piece housings or structures and still be within the scope of the invention.

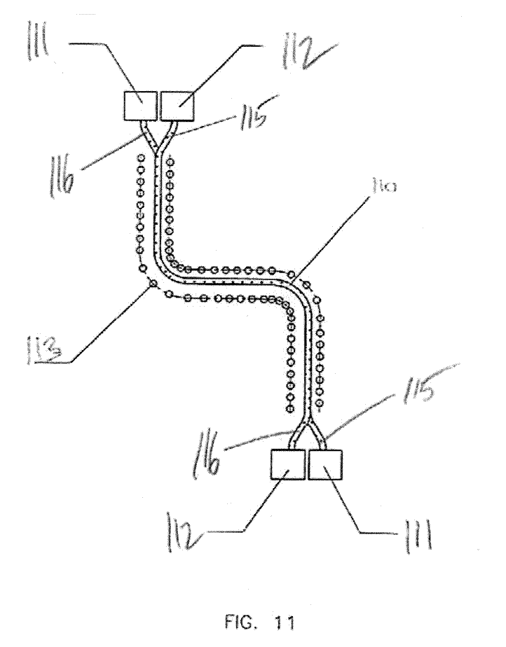

FIGS. 11 through 14 schematically illustrate the types of hinged phones and other devices through which the transceiver link 110 of the current invention could pass and connect the base of the unit to the video display. As shown in FIG. 11, two plastic fibers 115, 116 within flexible sheath 113 form two independent links between two photonic transmitters 111 and two photonic receivers 112 of the type previously described herein. These single sheath links can be used in devices such as flip phones having flip hinges, flip and twist hinges, and sliding portions. Flexible sheath 113 protects fibers 115, 116 from possible damage within the hinge or during the slide operation.

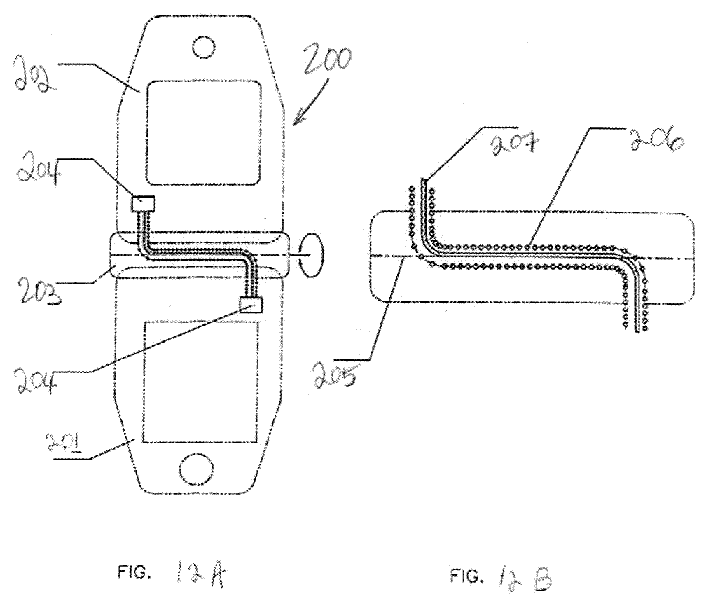

In FIGS. 12A and 12B, devices 200 having discreet video screens 202 and bases 201 and connected by a hinge 203 having a single degree of rotation, transceivers 204 are linked by two fibers 207 within flexible sheath 206 which pass through hinge 203 having flip axis 205. This construction enables rotation of the display 202 relative to base 201 up to 150° in open position.

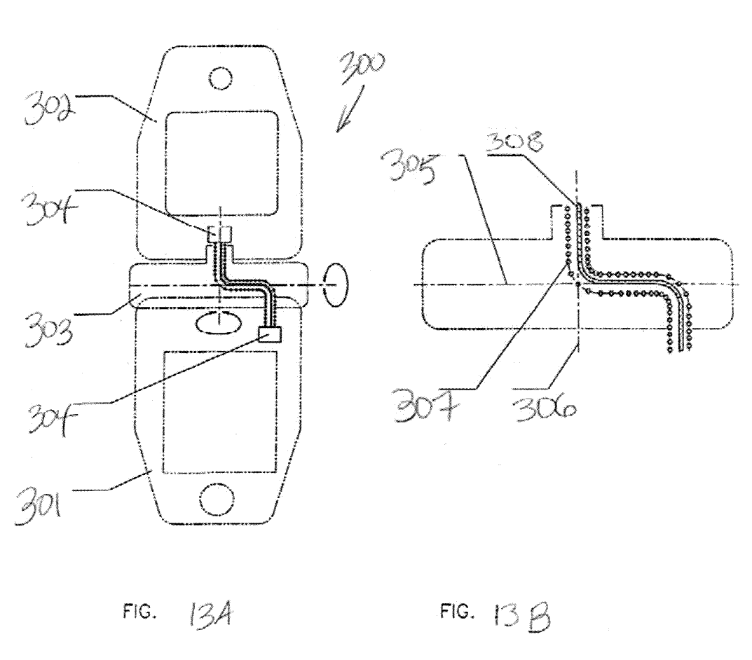

A flip and twist hinge embodiment is shown in FIGS. 13A and 13B. The device 300 enables twisting of display 302 relative to base 301 about twist axis 306, in addition to rotation about axis 305, so as to provide two degrees of motion. Transceivers 304 are linked by fibers 308 within sheath 307 passing within hinge 303.

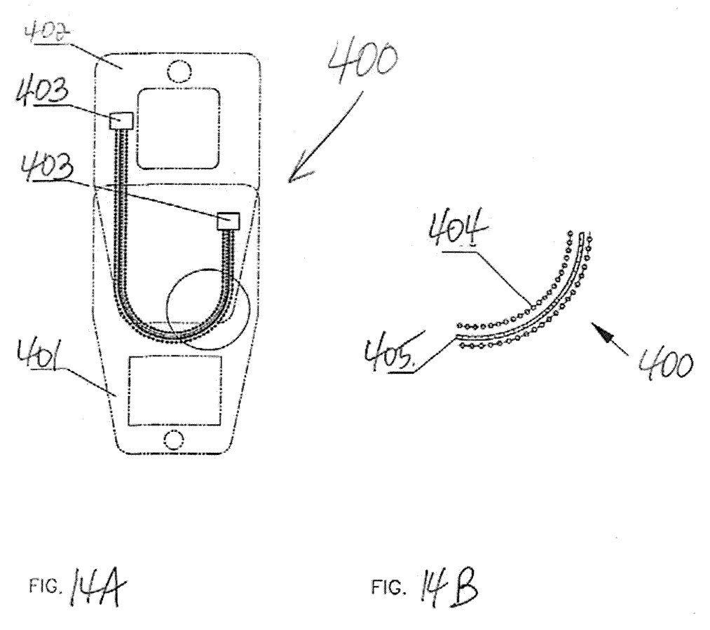

A sliding embodiment is provided in FIGS. 14A and 14B for a device 400 wherein a display portion 402 slides open or closed with respect to its base 401. Transceivers 403 are placed in each half and connected by fibers 405 within sheath 404.

It should further be considered within the scope of the invention to carry copper wire strands within the sheath, in addition to optic fibers to carry electrical current or to serve as a ground. The sheath itself can be used as a ground if necessary.

The present invention may be embodied in other specific forms without departing from its scope. The described embodiments are to be considered in all respects as only illustrative and not restrictive. All changes that come within the meaning and range of equivalency of the claims are to be embraced as being within the scope of the invention.

We claim:

1. An optical transceiver assembly, said transceiver assembly having transmission means and receiver means for sending and receiving an optical signal, said assembly affixed to at least one circuit board and comprising:
At least one optical fiber having two opposite ends and operably connected at least one end to at least one of said transmission means and said receiver means;
A housing serving as an adapter and connector in paired relationship, operably interposed between the optical fiber and said at least one of said transmission means and receiver means, to secure the optical fiber in engaged and aligned position with respect thereto; and,
Said optical fiber being surrounded by a flexible sheath to permit movement of the fiber without attenuation of the optical signal if the sheath is moved or twisted.

2. The assembly according to claim 1 wherein the transmission means comprises a VCSEL and a laser driver.

3. The assembly according to claim 1 wherein the receiver means comprises a photodiode and a TIA/LIA component.

4. An optical transceiver assembly having first and second ends, said transceiver assembly having at least one transmission means and at least one receiver means operably affixed at each end to at least one circuit board for transmitting and receiving the optical signal, said assembly comprising:
At least two optical fibers having two opposite ends and operably connected at each end to at least one of said transmission means and at least one of said receiver means;
A housing serving as an adapter and connector in paired relationship, operably interposed between the optical fiber and said at least one of said transmission means and receiver means, to secure the optical fiber in engaged and aligned position with respect to at least one of the transmission means and at least one of the receiver means at each end;
Each housing having at least one ferrule portion positioned therein to carry at least one of said fibers;
Said housing further including an alignment mechanism for precisely aligning said fibers with at least one of said transmission means or said receiver means;
Said housing further including an engagement mechanism for retaining said fibers in engaged and aligned position with respect to said transmission or receiver means; and,
Said optical fibers being surrounded by a flexible sheath for at least a portion of the span from one end of the fibers to the other to permit movement of one end of the assembly with respect to the other, without attenuation of the optical signal.

5. The assembly according to claim 4 wherein the housing comprises:
At least one fiber optic connector comprising at least one ferrule for carrying said fibers; and,
A fiber optic adapter interposed between the connector and the board for operably connecting to said connector and operably attaching it to said circuit board.

6. The assembly according to claim 4 wherein the alignment mechanism comprises:
the circuit board having at least one predetermined alignment hole formed therein and at least one alignment groove;
the housing having a pin portion protruding therefrom for aligned receipt by the alignment hole in the circuit board; and,
the housing further having one or more prongs protruding therefrom for receipt by the one or more alignment grooves of the circuit board.

7. The assembly according to claim 4 wherein the engagement mechanism comprises:
The connector having one or more slots;
The adapter having one or more latches about a substantially open interior for receipt of the connector within the interior thereof; and,
The latches of the adapter engaging the slots of the connector and thereby retaining the adapter in the interior of the connector.

8. An optical transceiver assembly for mounting on a mother board comprising:
A circuit board;
A laser driver operably mounted to said circuit board;
A VCSEL operably connected to the laser driver and mounted on said circuit board;
The laser driver and VCSEL cooperating to provide transmitter operation;
A photodiode in combination with a TIA/LA for providing receiver operation operably mounted on the circuit board; and,
The circuit board being operably affixed to the mother board in a substantially perpendicular orientation thereto so as to provide that the fibers are oriented in substantially parallel relation to the motherboard when connected thereto.

9. A method for passively aligning the optical fibers to the active components of an optical transceiver including a circuit board and an adapter/connector pair comprising the steps of:
Forming at least one alignment hole and at least one alignment groove into the circuit board at positions that will result in precise alignment of the optical fibers with the active components of the optical transceiver;
Providing an alignment pin and posts on the adapter/connector pair for corresponding engagement with the alignment hole and alignment groove of the circuit board;
Mounting the active optical components to the circuit board at specified locations thereon; and,
Joining the adapter/connector pair to the circuit board so that the alignment pin and alignment post are received by the corresponding alignment hole and alignment groove in secure and precisely aligned fashion.

10. An optical transceiver for use in devices having a first portion and a second portion that can each be moved with respect to the other portion, said transceiver having transmission means and receiver means affixed to a circuit board for transmitting and receiving an optical signal and comprising:
At least one optical fiber operably connected to said circuit board in precisely aligned fashion with respect to said transmission means and said receiver means;
At least one adapter/connector pair interposed between the optical fiber and the transmission means and the receiver means, to secure the optical fiber in engaged and precisely aligned position with respect thereto; and,
Said optical fiber being surrounded by a flexible sheath so as to permit passage of said fiber from said first portion of said device to said second portion of said device without attenuation of the optical signal when one of said device portions moves with respect to the other.

11. The transceiver of Claim 10 wherein the movement of the first portion of the device with respect to the second portion is rotation about a single axis defined by a hinge between the first and second portions.

12. The transceiver of claim 10 wherein the movement of the first portion of the device with respect to the second portion is rotation about either of two axes defined by one or more hinges positioned between the first and second portions.

13. The transceiver of claim 10 wherein the movement of the first portion of the device with respect to the second portion is sliding of a first portion of the device with respect to the second portion thereof.

14. An optical transceiver system for use in electronic devices containing active optical components having a first portion that moves with respect to a second portion of the device, said system comprising:
A first transceiver having transmission means and receiving means operably affixed to a circuit board within the first portion of the device for receiving and transmitting of an optical signal;
A second transceiver having transmission means and receiving means operably affixed to a circuit board within the second portion of the device;
At least one optic fiber operably connected to said first transceiver and said second transceiver and extending therebetween so as to enable the sending and the receiving of data therebetween;
An alignment mechanism interposed between the optic fiber and the circuit board for precise passive alignment of the fiber with said active optical components; and,
A protective sheath surrounding said fibers and preventing attenuation of the optical signal when the portions of the device are moved with respect to one another.

15. The system of claim 14 wherein the alignment mechanism comprises:
The active optical components being operably mounted to a circuit board at each portion of the device;
The circuit board having at least one alignment hole formed therein at a desired location;
The fiber being mounted to an adapter/connector pair at one end; and
The adapter/connector pair having a pin member at a desired location for receipt by the alignment hole in the circuit board.

16. An optical transceiver system for use in electronic devices containing active optical components, said system comprising:
A first transceiver having transmission means and receiving means operably affixed to a first circuit board;
A second transceiver having transmission means and receiving means operably affixed to a second circuit board;
At least one optic fiber operably connected to said first transceiver and said second transceiver and extending therebetween so as to enable the sending and the receiving of the optical signal therebetween; and,
A hermitization material applied to said optical components so as to substantially cover said optical components.

17. An optical transceiver assembly, said transceiver assembly having transmission means and receiver means for sending and receiving an optical signal, said assembly affixed to at least one circuit board and comprising:
At least one optical fiber having two opposite ends and operably connected at at least one end to at least one of said transmission means and said receiver means;
Said transmission means and said receiver means each including at least one active component;
A housing serving as an adapter and connector in paired relationship, operably interposed between the optical fiber and said active components, to secure the optical fiber in engaged and aligned position with respect thereto; and,
Said adapter being formed of a transparent material so as to separate said fiber and said active component and facilitate hermitization of said active component with hermitizing material.

18. The assembly of claim 17 wherein said active components comprise a VCSEL and a PD.

19. The assembly of claim 17 wherein said hermitizing material is a transparent optical adhesive.

20. An optical transceiver assembly, said transceiver assembly having transmission means and receiver means for sending and receiving an optical signal, said assembly affixed to at least one circuit board and comprising:
At least one optical fiber having two opposite ends and operably connected at least one end to at least one of said transmission means and said receiver means;
Said transmission means and said receiver means each including at least one active component;
A housing serving as an adapter and connector in paired relationship, operably interposed between the optical fiber and said active components, to secure the optical fiber in engaged and aligned position with respect thereto;
Said adapter being formed of a transparent material so as to separate said fiber and said active component; and,
Said adapter having a lens formed therein for optimal launching of the optical signal from the transmission means to the fiber.
